(19) United States
(12) Patent Application Publication
(10) Pub. No.: US 2006/0263589 A1
(43) Pub. Date: Nov. 23, 2006

(54) Single packaged, self contained odor absorbers

(76) Inventor: Gregory M. Todd, Florence, SC (US)

Correspondence Address: Gregory M. Todd, 3801 Brookefield Road, Florence, SC, 29505, US

(21) Appl. No.: 11/132,942

(22) Filed: May 19, 2005

(51) Int. Cl. B32B 3/06

(52) U.S. Cl. 428/307.3

(57) ABSTRACT

A packet of varying shapes and sizes to be made of cotton, pellon or other breathable fabric which contains baking soda or other odor absorbing component with the odor absorbing materials to be completely contained on the packet with the packet being sewn, glued or fused at every edge to prevent leakage of the odor absorbing materials. The size, shape and style of the packet will be determined by the area and type of odor to be absorbed. Each packet can be used independently or encased in a separate zipped, buttoned or otherwise accessible opening at one edge with the casing packets to be decorative and colorful. The packets will be used to combat and absorb undesirable odors.

### CROSS REFERENCE TO RELATED APPLICATIONS

None

### FEDERALLY SPONSORED RESEARCH

Not Applicable

### SEQUENCE LISTING OR PROGRAM

Not Applicable

### BACKGROUND OF INVENTION

This invention relates to addressing odors through the use of an odor absorbing component contained in single, self contained packets of various sizes, shapes and decorations.

### PRIOR ART

Consumers use various air fresheners to combat odors in various places to include, but not limited to, vehicles, homes, offices, sleeping bags, diaper pails, shoes, closets, trashcans, bathrooms, kitchens, bedrooms and other areas in which offensive odors are present. The available solutions to permit consumers to address offensive odors include unattractively packaged boxes of baking soda or fragrant air fresheners. Air fresheners are marketed in aerosol sprays, plug-ins, pop-ups and fragrant card board. These marketed air fresheners do not absorb the odors but merely attempt to camouflage, cover and conceal the odor with a more pleasant scent. The current invention provides a mechanism to combat and absorb odors not simply cover them up. Further, this invention while directly addresses the odor through an odor absorbing agent, is also self contained in a decoratively packaged, convenient packet.

### OBJECTS AND ADVANTAGES

The advantages of the instant invention are:

(a) To provide a device to contain an odor absorbing material in a size and volume to vary dependent upon the size of area in which the device will be used to combat odors;

(b) To provide a device that will be packaged in a colorful and decorative fabric reflective of the area in which the consumer will use the odor absorbing packet;

(c) To provide a device that will provide the consumer with an option to combat odors not through a mechanism that introduces a fragrance into the air to camouflage, conceal or cover up the odor but instead absorbs the odor through an odor absorbing material;

(d) To provide a device which can easily and conveniently be used and replaced;

(e) To provide a device to absorb odors which can be packaged in attractive and decorative coverings to coordinate with the use selected by the user. For example, a camouflage printed material may be used to make a separate cover for the packet for use in areas in which hunting clothing is stored, or in boots, or outdoor sleeping bags. Pastel theme prints may be used to coordinate with a baby nursery for use in diaper pails, drawers and closets. Satin or feminine prints may be used for packets used in women's lingerie drawers and closets. The list is nonexhaustive dependent or limited only as to the various places consumers wish to place the packet to combat odor.

### SUMMARY

The present invention is a self-contained packet of odor absorbing material with the size, shape, amount of odor absorbing material, and decorative coverings to correspond, reflect and respond to the use intended by the consumer.

### DRAWINGS

FIG. 1 shows an example of a packet to contain odor absorbing materials with the drawing reflecting the initial layout of the packet prior to insertion of the odor absorbing material and fusion of the edges of the packet

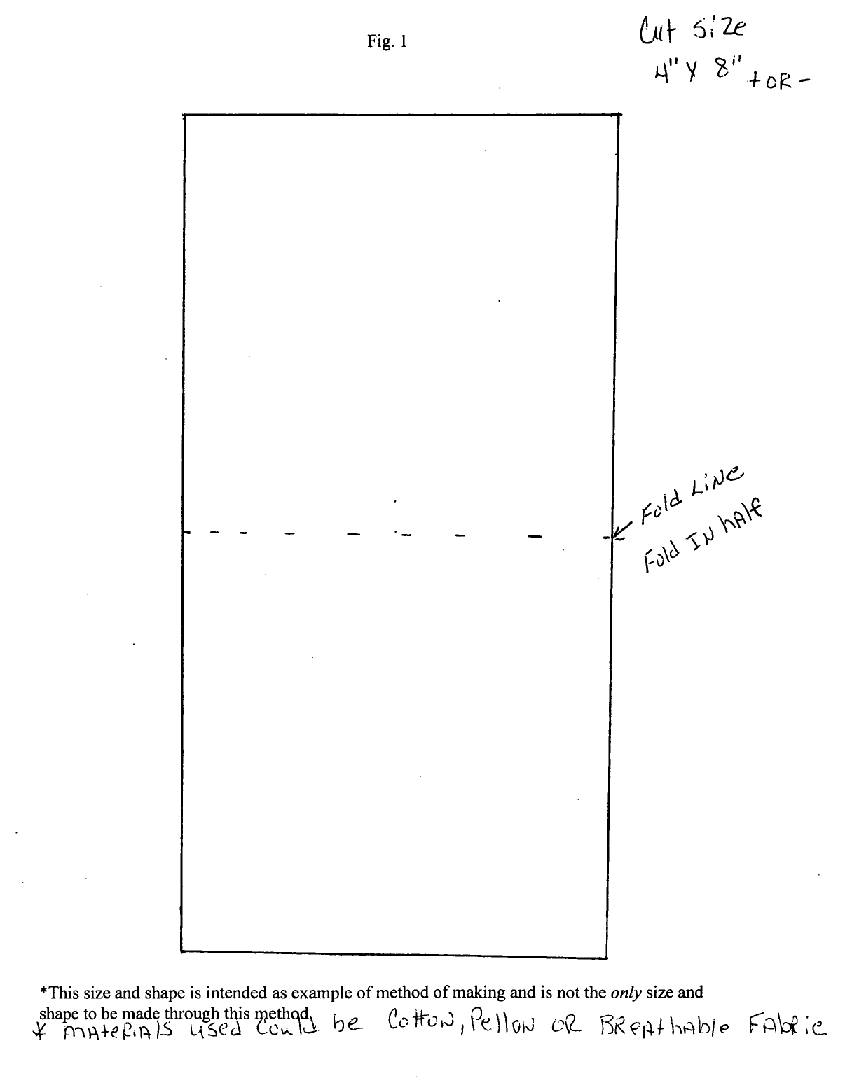

FIG. 2 shows the manner in which the packet will be sealed by sewing, gluing or other method of fusion prior to inserting the odor absorbing material.

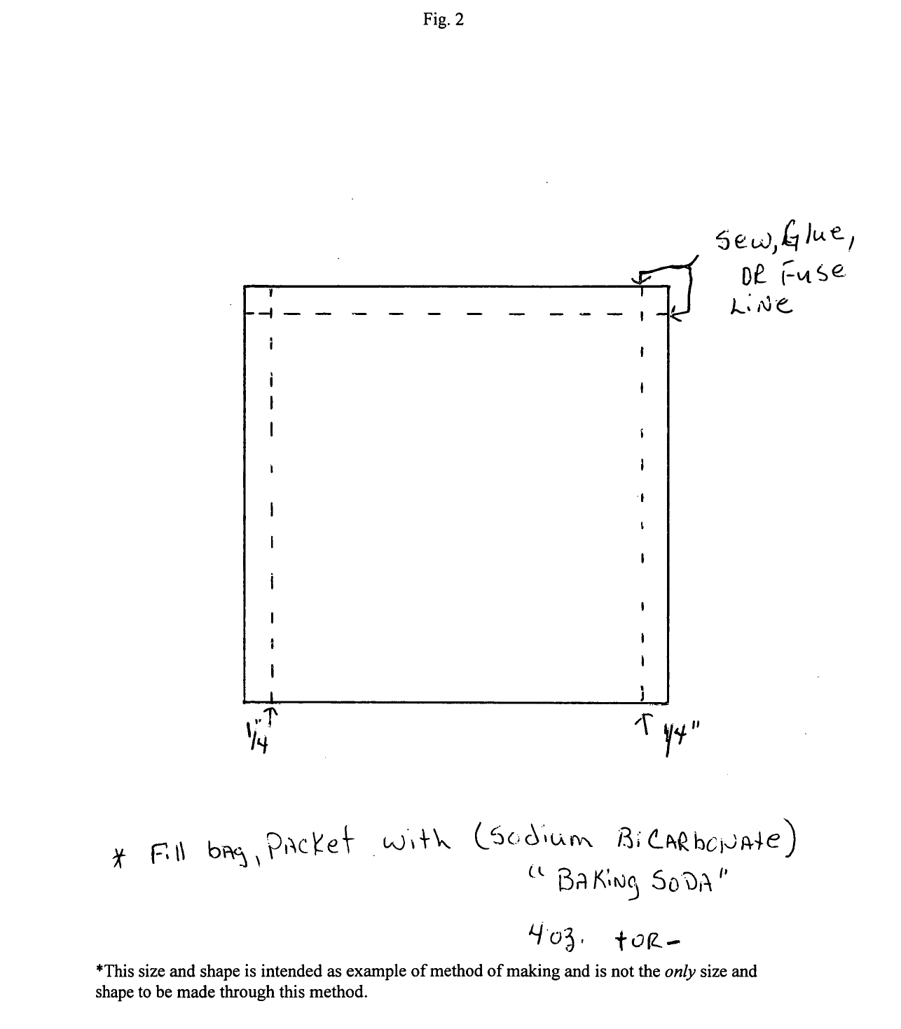

FIG. 3 shows the final step of sealing the packet after the odor absorbing materials have been placed in the packet.

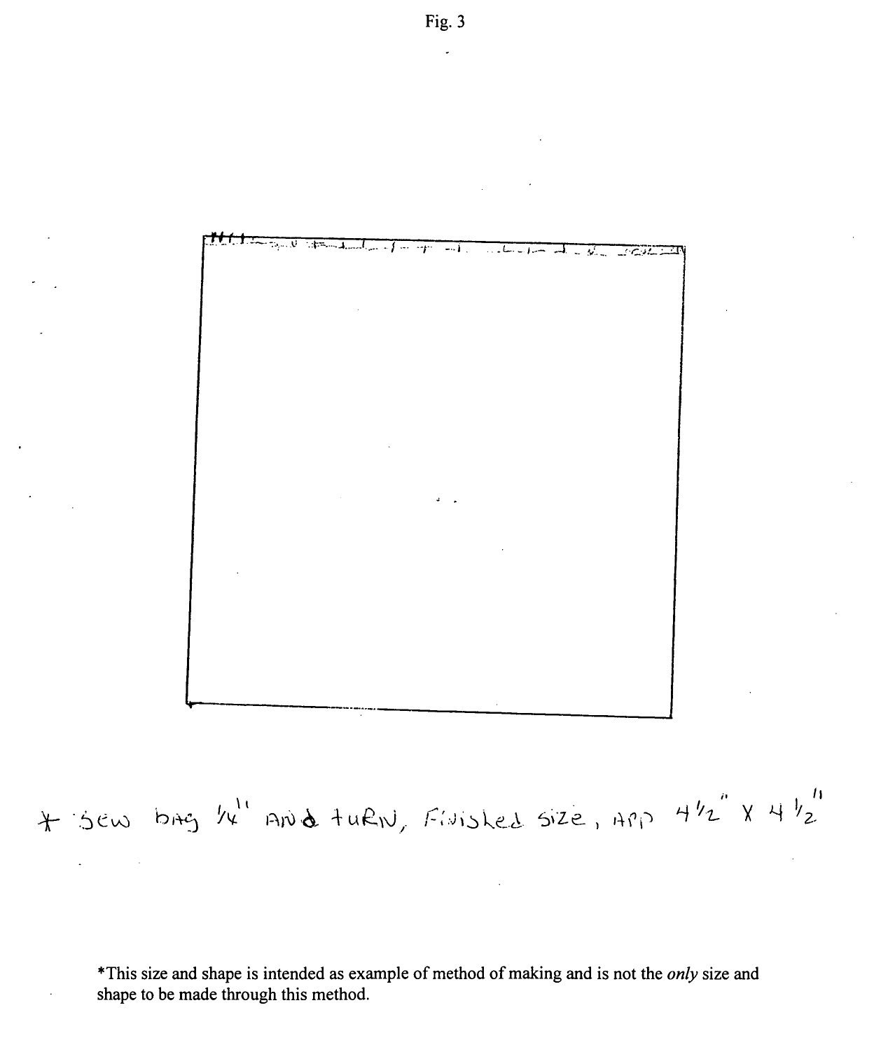

FIG. 4 shows an optional separate packet that may be used to encase the odor absorbing packet with FIG. 4 being a reusable packet made of decorative cotton, pellon or other breathable fabric with one edge being zipped, buttoned or otherwise accessible for opening and closure to provide for the insertion of a fresh odor absorbing packet identified in FIGS. 1 through 3.

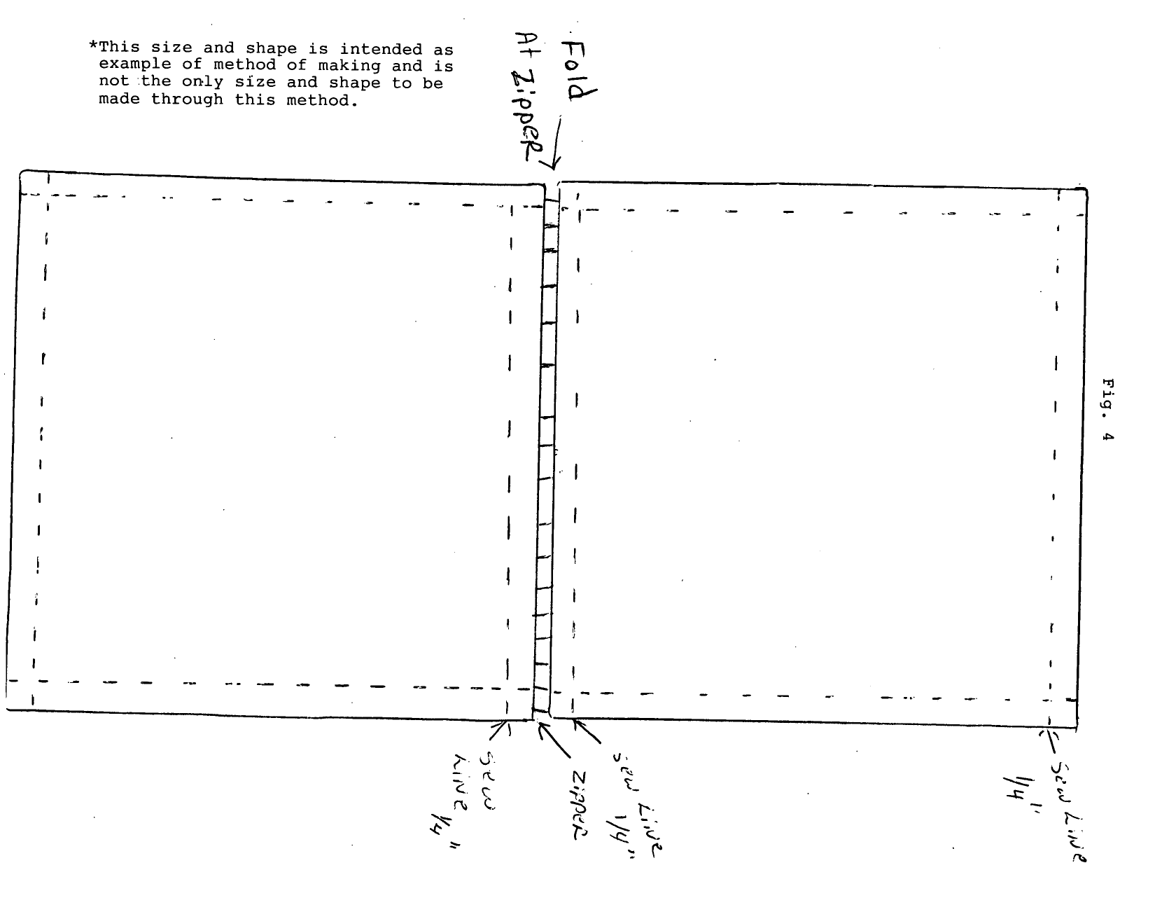

The descriptions and figures show a square packet of a specified size. However, these specifications should not be construed as limiting the scope of the invention but as merely providing an illustration of the manner in which the odor absorbing materials will be embodied and contained. For example, the odor absorbing packets may vary in shapes to include, but not limited to, circular, oval, trapezoidal and triangular.

Based upon the foregoing, the scope of this invention should be determined by the attached claims and their legal equivalents rather that by the specific example set forth above.

1. A device for absorbing odors comprising:
1. A flat piece of material made from cotton, pellon or other breathable fabric;
2. Said material to be folded, sewn, glued or otherwise conformed into a packet to be closed at each edge by being sewn, glued or fused;
3. Prior to sewing, gluing or fusing for closure of the packet at every edge for purposes of completely sealing of the packet, the packet shall be filled with an odor absorbing material such as baking soda or other comparable substance in an amount consistent with the size of the packet, with such sizes to vary, filling the packet with the odor absorbing material;

2. The material identified in claim 1. shall be white, solid colored or a printed fabric to coordinate the color or printed fabric in a decorative manner to reflect, correspond or be consistent with the area in which the packet will be used.

3. Each packet can be further encased in a separate packet for decorative purposes with the separate packet to be reusable with one edge easily accessible by zipper, button or other method for opening and closing.

4. The size of the packet identified in claim 1. shall vary to correspond to the area in which the packet will be placed to combat odors.
